(19) United States
(12) Patent Application Publication
(10) Pub. No.: US 2005/0235616 A1
(43) Pub. Date: Oct. 27, 2005

(54) Motorcycle air intake filter

(76) Inventor: John Boston, Laguna Niguel, CA (US)

Correspondence Address: RUTH EURE, 4795 EDISON AVENUE, BOULDER, CO, 80301, US

(21) Appl. No.: 11/111,027

(22) Filed: Apr. 21, 2005

Related U.S. Application Data
(60) Provisional application No. 60/563,986, filed on Apr. 21, 2004.

(51) Int. Cl. B01D 46/00

(52) U.S. Cl. 55/385.3

(57) ABSTRACT

This invention provides an air intake filtering device for a motorcycle including a washable filtering foam material; a filtering material supporting means; and a means for removably attaching the device to an air intake portion of a motorcycle. This invention provides a method for filtering air entering or within an air intake portion of a motorcycle including: attaching a device of this invention to the air intake portion; and passing air through the washable filtering material.

### CROSS-REFERENCE TO RELATED APPLICATIONS

This application claims priority under 35 USC 119(e) to provisional patent applications Ser. No. 60/563,986, filed Apr. 21, 2004, the entirety of which is herein incorporated by reference.

### FIELD OF THE INVENTION

This invention is in the field of air intake filters, specifically motorcycle air intake filters.

### BACKGROUND

Motorcycles typically have an air cleaner and/or an air intake filter for cleaning the air before it enters the engine. Without an air cleaner or filter, dirt will enter the engine and destroy the engine over time. Many air cleaners and filters decrease the amount of air that can enter the engine, thus causing the engine's power output to decrease. Therefore it is important to utilize a cleaner or filter that effectively cleans the air but does not substantially decrease air flow.

Known air intake filters include oiled foam, oiled fabric, and dry paper. In the oiled foam and fabric filters, the oil acts as the filter and the foam or fabric acts as the carrier. In the dry paper filters, dust and dirt clog the pores in the filter, decreasing the air flow and decreasing the engine performance. Disposable filters need to be changed often, resulting in a regular maintenance expense.

There is a need in the art for an inexpensive, efficient, easily maintainable, easily and environmentally friendly washable motorcycle air intake filter.

### SUMMARY

This invention provides an air intake filtering device for a motorcycle comprising: a washable filtering material; a filtering material supporting means; and a means for removably attaching the device to an air intake portion of a motorcycle. In an embodiment, the device or the filtering material supporting means is configured to attach to the opening of a stock airbox of the air intake portion of the motorcycle or to the opening of a carburetor of the motorcycle. In an embodiment, the device or filtering support means is configured to attach to the air intake structure of the carburetor of the motorcycle.

In an embodiment, the washable filtering material is washable and reusable for about the lifetime of the motorcycle. In an embodiment, the washable filtering material is washable with solvent, such as gasoline, kerosene, acetone, or alcohol, for example. In an embodiment the filtering material is washable with an organic solvent. In an embodiment, the device or the filtering material support means is configured for the washable filtering material to be easily visually inspected for determining when the material should be washed.

In an embodiment, the washable filtering means comprises open-celled foam and has a selected number of pores per square or cubic inch. In an embodiment, the foam is hydrophilic. In an embodiment, the foam has a selected thickness.

In an embodiment, the filtering material support means comprises a photopermeable material such as plexiglass for easy visual inspection and determination of the need to wash the filtering material.

This invention provides a method for filtering air entering or within an air intake portion of a motorcycle comprising: attaching a device of this invention to the air intake portion; and passing air through the washable filtering material. In an embodiment, the method further comprises a step of washing the washable filtering material.

In an embodiment, the method further comprises driving or riding or running the motorcycle for a selected number of miles before performing the step of washing the washable filtering material. In an embodiment, the method comprises washing the washable filtering material a selected number of times. In an embodiment, washing comprises cleaning the washable filtering material by hand washing in a basin or other container with solvent such as gasoline, for example.

In an embodiment, the method further comprises: visually inspecting the filtering material to determine the need for washing, removing said filtering material, and after washing, replacing said washed filtered material.

In an embodiment, an air intake filtering device of this invention attaches directly to the air intake opening of the carburetor, eliminating the need for a separate air cleaning device.

As used herein, the term “solvent” refers to any liquid which is effective in removing dirt and debris from the washable filter material. Examples include, but are not limited to: gasoline, kerosene, acetone, alcohol, or other organic or inorganic liquid which is effective for the above-stated purpose.

### BRIEF DESCRIPTION OF THE DRAWINGS

FIG. 1A is an illustration of a front view of a motorcycle air intake filter device of this invention and FIG. 1B is a side view.

FIG. 2 is an illustration of an exploded perspective view of a carburetor and an air intake filter device of this invention.

### DETAILED DESCRIPTION

This invention provides an air intake filtering device for a motorcycle comprising: a washable filtering material; a filtering material supporting means; and a means for removably attaching the device to an air intake portion of a motorcycle. In an embodiment, the device or the filtering material supporting means is configured to attach to the outside opening of a stock airbox of the air intake portion of the motorcycle or to the opening of a carburetor of the motorcycle. In an embodiment, the device or filtering support means is configured to attach to the air intake structure of the carburetor of the motorcycle.

In an embodiment, the device is configured to increase the internal volume of the stock airbox relative to the stock airbox with a standard filtering device comprising a standard filter and standard lid. This increase in internal volume of the stock airbox results from the removal of the standard filtering device and replacement by the present invention mounted on the outside of the airbox.

The filtering device of the present invention is designed to be utilized on the outside of the airbox.

The filtering device of the present invention increases the air flow into the airbox by increasing the size of the opening to the airbox. The filtering device of the present invention increases the effective size of the opening to the airbox by a factor of about 2, 3, or 4.

In an embodiment, the washable filtering material is washable and reusable for about the lifetime of the motorcycle. In an embodiment, the washable filtering material is washable with solvent such as gasoline, for example. In an embodiment the filtering material is washable with an organic solvent, such as kerosene, acetone, or alcohol, for example.

In an embodiment, the device is for a purpose selected from the group consisting of: increasing total air flow per unit time through the air intake portion, increasing cleanliness of air in the air intake portion, improving engine efficiency, improving fuel economy of the motorcycle, and reducing exhaust emissions from the motorcycle.

In an embodiment, the device or the filtering material support means is configured for the washable filtering material to be easily visually inspected for determining when the material should be washed.

In an embodiment, the washable filtering means comprises open-celled foam. In an embodiment, the foam has a number of pores per square or cubic inch selected from the group consisting of: between about 20 and about 200, between about 40 and about 100, between about 50 and about 75, between about 55 and about 65, and about 60. In an embodiment, the foam is hydrophilic. In an embodiment, the foam has a thickness selected from the group consisting of: between about ¼ inch and 2 inches, between about ⅓ and about 1 inch, between about ½ inch and about ¾ inch, and about ⅝ inch.

In an embodiment, the filtering material support means comprises plexiglass. In an embodiment, the device comprises oil and/or does require oiling. Oils suitable for this purpose include, but are not limited to: motor and engines oils such as 30w motor oil, for example.

In an embodiment, the washable filtering material comprises open-celled hydrophilic foam comprising about 60 pores per square or cubic inch that is about ⅝ inch thick.

This invention provides a method for filtering air entering or within an air intake portion of a motorcycle comprising: attaching a device of this invention to the air intake portion; and passing air through the washable filtering material.

This invention provides a method for increasing midrange power of a motorcycle engine comprising: providing a device of this invention; attaching the device to the motorcycle; running the motorcycle wherein air in the air intake portion of the motorcycle is filtered by the device; relative to an equivalent context using a standard filtering device.

This invention provides a method for filtering air entering or within an air intake portion of a motorcycle comprising: providing a washable air intake filtering device for a motorcycle comprising: a washable filtering material; a filtering material supporting means; and a means for removably attaching the device to the air intake portion of the motorcycle; removably attaching the device to the air intake portion of the motorcycle; and allowing air to pass through the filtering material. In an embodiment, the method further comprises a step of washing the washable filtering material.

In an embodiment, the method further comprises driving or riding or running the motorcycle for an amount selected from the group consisting of: more than about 2000 miles, more than about 3500 miles, more than about 5000 miles, more than about 7500 miles, more than about 10,000 miles, more than about 25,000 miles, more than about 50,000 miles, more than about 100,000 miles, more than about 500,000 miles, and more than about 1,000,000 miles before performing the step of washing the washable filtering material.

In an embodiment, the method comprises washing the washable filtering material a number of times selected from the group consisting of: more than 25 times, more than 28 times, more than about 30 times, more than about 50 times, more than about 100 times, and more than about 250 times. In an embodiment, washing comprises cleaning the washable filtering material by hand in a container of solvent, or running the solvent through the filter.

In an embodiment, the method further comprises: visually inspecting the filtering material to determine the need for washing, removing said filtering material, and after washing, replacing said washed filtered material. In an embodiment, the method further comprises drying said filtering material before replacing it.

In an embodiment, the device replaces opening of a stock airbox of the air intake portion of the motorcycle or a carburetor. In an embodiment, the method does include a step of oiling the washable filtering material.

In an embodiment, an air intake filtering device of this invention replaces the air intake opening of the carburetor, eliminating the need for a separate air cleaning device.

In an embodiment, the filtering material is Filter Foam #60 available from Unifilter Inc. (Fullerton, Calif., USA). In an embodiment, the filtering material support means comprises plexiglass.

In an embodiment, the devices of this invention conform to any and all regulatory requirements for such devices.

In an embodiment, the washable filtering material is strong enough to withstand use and washing and is open enough to allow sufficient air to flow through at a sufficient quantity and rate so as to not substantially decrease engine output. In an embodiment, the filtering material support means is strong enough to support the washable filtering material on the air intake opening. In an embodiment, the support means is photopermeable to sufficient photoradiation visible to the human eye to allow for easy visual inspection of the filtering material to allow for determination of the need for washing.

The elements labeled in the drawings are summarized in Table 1 below:

TABLE 1

| Number | Name of Element |
|---|---|
| 1 | air intake filtering device |
| 2 | washable filtering material |
| 3 | filtering material support means |
| 4 | means for removably attaching device |
| 5 | carburetor |
| 6 | air intake opening |
| 7 | filtering material cross-sectional area opening |
| 8 | filtering material thickness |
| 9 | screw |

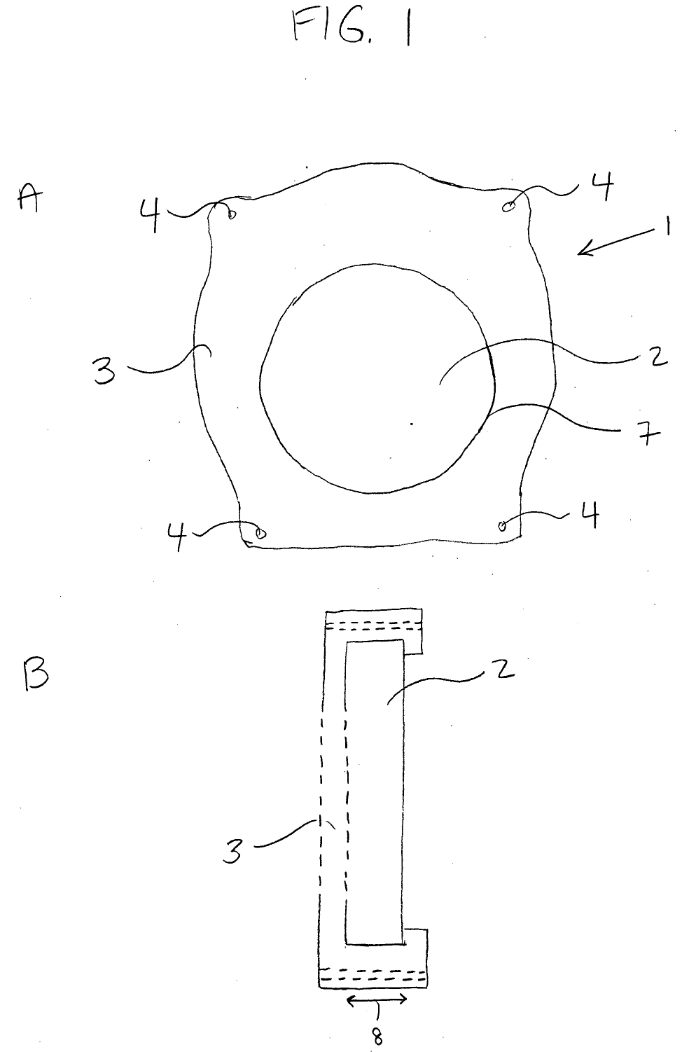

FIG. 1A shows a front view illustration of an air intake filtering device 1 of this invention. The device, specifically the filtering material support means 3 is configured to attach to the air intake of a motorcycle by four holes 4 through which screws can fit. The washable filtering material 2 is foam and the filtering material support means has an opening 7 which determines the filtering material cross-sectional area. FIG. 1B shows the filtering material thickness 8.

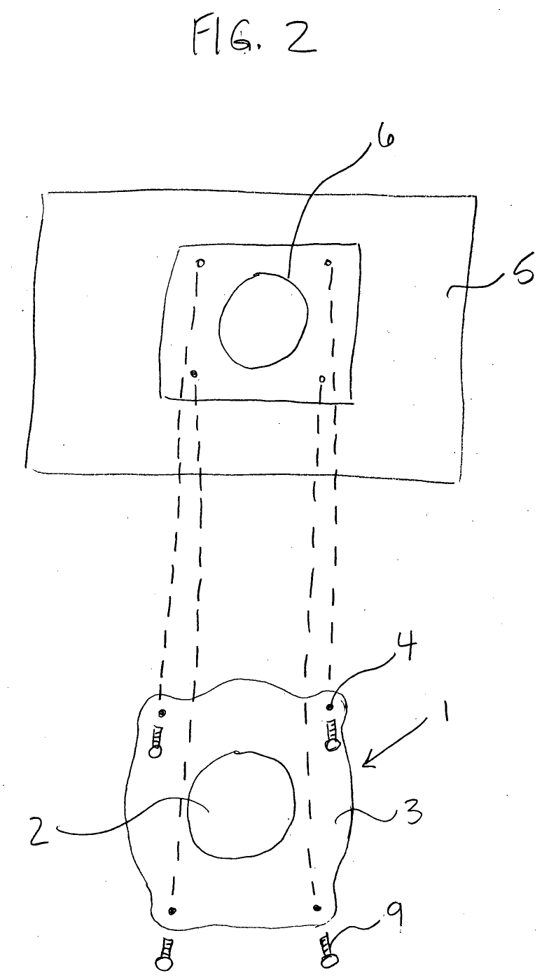

FIG. 2 shows an illustration of an exploded perspective view of a carburetor 5 and an air intake filtering device 1 of this invention. The means for removably attaching the device 4 to the air intake opening 6 of the carburetor are shown (screws 9).

Materials useful in the practice of this invention include, but are not limited to, hydrophilic open-celled foams, substantially rigid plastics, plexiglass, screws, and nuts. Washable filter materials, filter material support materials, and filtering device attachment materials and methods known in the art or as yet to be invented are useful in the practice of this invention.

Although this invention has been described with respect to specific embodiments, it is not intended to be limited thereto, and various modifications which will become apparent to the person of ordinary skill in the art are intended to fall within the scope of the invention as described herein, taken in conjunction with the accompanying drawings and the appended claims.

1. An air intake filtering device for a motorcycle comprising:
a) a washable filtering material;
b) a filtering material supporting means; and
c) a means for removably attaching said device to an air intake portion of a motorcycle.

2. The device of claim 1 wherein said washable filtering material is washable and reusable for about the lifetime of said motorcycle or for a number of washings selected from the group consisting of: more than 25 times, more than 28 times, more than about 30 times, more than about 50 times, more than about 100 times, and more than about 250 times.

3. The device of claim 1 wherein said washable filtering material is washable with solvent.

4. The device of claim 1 that is configured for said washable filtering material to be easily visually inspected for determining when said material should be washed.

5. The device of claim 1 wherein said washable filtering means comprises open-celled foam.

6. The device of claim 5 wherein said foam has a number of pores per square inch selected from the group consisting of: between about 20 and about 200, between about 40 and about 100, between about 50 and about 75, between about 55 and about 65, and about 60.

7. The device of claim 5 wherein said foam is hydrophilic.

8. The device of claim 1 wherein said foam has a thickness selected from the group consisting of: between about ¼ inch and 2 inches, between about ⅓ inch and about 1 inch, between about ½ inch and about ¾ inch, and about ⅝ inch.

9. The device of claim 1 wherein said filtering material support means comprises plexiglass.

10. The device of claim 1 that does comprise oil or require oiling.

11. The device of claim 1 wherein said washable filtering material comprises hydrophilic foam comprising about 60 pores per square inch that is about ⅝ inch thick.

12. A method for filtering air entering or within an air intake portion of a motorcycle comprising:
a) attaching a device of claim 1 to said air intake portion; and
b) passing air through said washable filtering material.

13. A method for filtering air entering or within an air intake portion of a motorcycle comprising:
a) providing a washable air intake filtering device for a motorcycle comprising:
1) a washable filtering material;
2) a filtering material supporting means; and
3) a means for removably attaching said device to said air intake portion of said motorcycle;
b) removably attaching said device to said air intake portion of said motorcycle; and
c) allowing air to pass through said filtering material.

14. The method of claim 13 further comprising a step of washing said washable filtering material using solvent.

15. The method of claim 14 further comprising driving said motorcycle for an amount selected from the group consisting of: more than about 2000 miles, more than about 3500 miles, more than about 5000 miles, more than about 7500 miles, more than about 10,000 miles, more than about 25,000 miles, more than about 50,000 miles, more than about 100,000 miles, more than about 500,000 miles, and more than about 1,000,000 miles before performing said step of washing said washable filtering material.

16. The method of claim 14 comprising washing said washable filtering material a number of times selected from the group consisting of: more than 25 times, more than 28 times, more than about 30 times, more than about 50 times, more than about 100 times, and more than about 250 times.

17. The method of claim 13 wherein said device is attached to the opening of a stock airbox of said air intake portion of said motorcycle or the air intake of a carburetor of said motorcycle.

18. The method of claim 13 that does include a step of oiling said washable filtering material.
